(19) United States
(12) Patent Application Publication
(10) Pub. No.: US 2004/0264934 A1
(43) Pub. Date: Dec. 30, 2004

(54) Device and method for recording on and playing back a disc

(76) Inventor: Koji Ishikawa, Iwaki-city (JP)

Correspondence Address: BRINKS HOFER GILSON & LIONE, P.O. BOX 10395, CHICAGO, IL, 60610, US

(21) Appl. No.: 10/863,656

(22) Filed: Jun. 8, 2004

(30) Foreign Application Priority Data
Jun. 11, 2003 (JP) 2003-165829

(51) Int. Cl. G11B 7/085

(52) U.S. Cl. 386/95; 386/124

(57) ABSTRACT

A disc recording/playback device includes a system controller that confirms whether or not a user desires updating of content included in resume marker information in an optical disc. When it is confirmed that the updating of the content of the resume marker information is desired by the user, the system controller updates the content of the resume marker information and sends an ejection command to eject the optical disc from the device. Otherwise, the previous content included in the resume marker information is maintained and the disc is ejected.

### BACKGROUND OF THE INVENTION

1. Field of the Invention

The present invention relates to a device and a method for recording video data on a disc and playing back video data recorded on a disc.

2. Description of the Related Art

Japanese Unexamined Patent Application Publication No. 11-297052 discloses a conventional disc playback device that is provided with a resume function. According to such a resume function, resume information that contains playback starting point data for a subsequent playback operation is written in a data management area of an optical-disc recording medium such that the previously-stopped point is automatically set as the playback starting point for the subsequent playback operation. According to such a disc playback device, the resume operation is ensured regardless of whether the optical-disc recording medium is ejected or is loaded into other disc playback devices because the resume information is stored in the data management area of the optical-disc recording medium.

As described above, in the disc playback device of Japanese Unexamined Patent Application Publication No. 11-297052, the resume information stored in the data management area (TOC area) of the optical-disc recording medium is updated each time the optical-disc recording medium is ejected from the device such that the previously-stopped point is automatically set as the playback starting point for the subsequent playback operation. This is disadvantageous in view of playing back the optical-disc recording medium from a desired playback point. For example, when the optical-disc recording medium is played back from the user's desired playback point, even if the user desires to playback the optical-disc recording medium from the same point in the subsequent playback operation, the playback starting point is automatically updated each time the optical-disc recording medium is ejected. This means that, for playing back the optical-disc recording medium from the original desired playback point in the subsequent playback operation, the user has to search for this point manually by using an operating unit. Moreover, this is problematic in a case where there are multiple optical-disc recording media since the user has to remember the desired playback point for each optical-disc recording medium.

### SUMMARY OF THE INVENTION

Accordingly, it is an object of the present invention to provide a device and a method for recording and playing back a disc, in which a user can select a mode for updating the resume information such that the disc can be played back from a desired playback starting point.

A disc recording/playback device according to a present embodiment reads data from and writes data on a disc recording medium, and includes a resume-data reading element for reading resume information that is written in a recording area of the disc recording medium and that includes playback starting point data; a playback element that reads and plays back recorded data on the disc recording medium from a playback starting point based on the playback starting point data of the resume information read by the resume-data reading element; a confirmation element for confirming whether or not a user desires updating of content included in the resume information when an ejection command for the disc recording medium is received from the user; a resume-data updating element that updates the content of the resume information by setting a current playback point on the disc recording medium read by the playback element as a new playback starting point if the confirmation element confirms that the updating of the content of the resume information is desired by the user, and that does not update the content of the resume information if the confirmation element confirms that the updating of the content of the resume information is not desired by the user; and a disc-ejecting element for ejecting the disc recording medium in response to the ejection command for the disc recording medium received from the user after the operations of the confirmation element and the resume-data updating element are completed.

Furthermore, another embodiment provides a method for reading data from and writing data on a disc recording medium in the disc recording/playback device. This method includes a first act of reading the resume information written in the recording area of the disc recording medium, the resume information including the playback starting point data; a second act of reading and playing back recorded data on the disc recording medium from a playback starting point based on the playback starting point data of the resume information read in the first act; a third act of confirming whether or not a user desires updating of content included in the resume information when an ejection command for the disc recording medium is received from the user; a fourth act of updating the content of the resume information by setting a current playback point on the disc recording medium as a new playback starting point if it is confirmed in the third act that the updating of the content of the resume information is desired by the user, and not updating the content of the resume information if it is confirmed in the third step that the updating of the content of the resume information is not desired by the user; and a fifth act of ejecting the disc recording medium in response to the ejection command for the disc recording medium received from the user after the third and fourth acts are completed.

Accordingly, when the ejection command for the disc recording medium is received from the user, the disc recording/playback device asks the user whether he/she desires updating of the resume marker information and offers options for the user with regard to the updating of the resume marker information. This means that if the resume marker information is not updated, the previous starting point data can be maintained. This allows the playback operation to begin from the user's desired playback starting point.

Furthermore, the disc recording/playback device is preferably provided with an operating unit through which the user can send the ejection command for the disc recording medium. Accordingly, the operationability of the disc recording/playback device is improved due to the fact that the disc recording/playback device allows the user to select whether or not to update the resume marker information just as he/she enters an ejection command for the disc recording medium via the operating unit.

Furthermore, the disc recording medium is preferably an optical disc that complies with a DVD-VR standard. In particular, the resume information is preferably written in the optical disc as resume marker information provided in a video manager information management table in the optical disc. Although DVD-VR standard is provided with only one area in which subsequent playback starting point data can be written, i.e. the resume marker information, since the method according to one embodiment allows the user to choose whether or not to update the content included in this area, the optical disc can be played back from the user's desired playback starting point.

Furthermore, the disc recording/playback device is preferably provided with a set-up element through which the user can select between a confirmation mode for confirming an update of the resume information and an automatic update mode for automatically updating the resume information. In this case, the confirmation mode is performed by the confirmation element and the automatic update mode is performed without the confirmation by the confirmation element. Accordingly, if the user selects the automatic update mode, the resume marker information will be automatically updated in the process of each ejecting operation for the optical disc, as in the conventional method. This reduces the operational steps in a case where the method of this embodiment is not applied.

Furthermore, the set-up element preferably includes a predetermined set-up screen and operates independently of the playback operation for the data recorded on the disc recording medium via the set-up screen. Accordingly, the set-up process on the set-up screen of the set-up element can be performed without having to stop the playback operation. This maintains the interchangeability between a method of a present embodiment and the conventional method for automatically updating the resume marker information.

### BRIEF DESCRIPTION OF THE DRAWINGS

FIG. 1 is a schematic diagram of a disc recording/playback device according to an embodiment of the present invention;

FIG. 2 illustrates the format of data written on an optical disc;

FIG. 3 is a flow chart illustrating the operational procedure of the disc recording/playback device according to the embodiment of the present invention;

FIG. 4 illustrates an example of a set-up screen;

FIG. 5 illustrates an example of an update confirmation screen on which a user is asked whether he/she desires updating of resume marker information; and

FIG. 6 illustrates an operative example of the disc recording/playback device according to the embodiment of the present invention.

### DESCRIPTION OF THE PREFERRED EMBODIMENTS

Embodiments of a disc recording/playback device 1 will now be described with reference to the drawings.

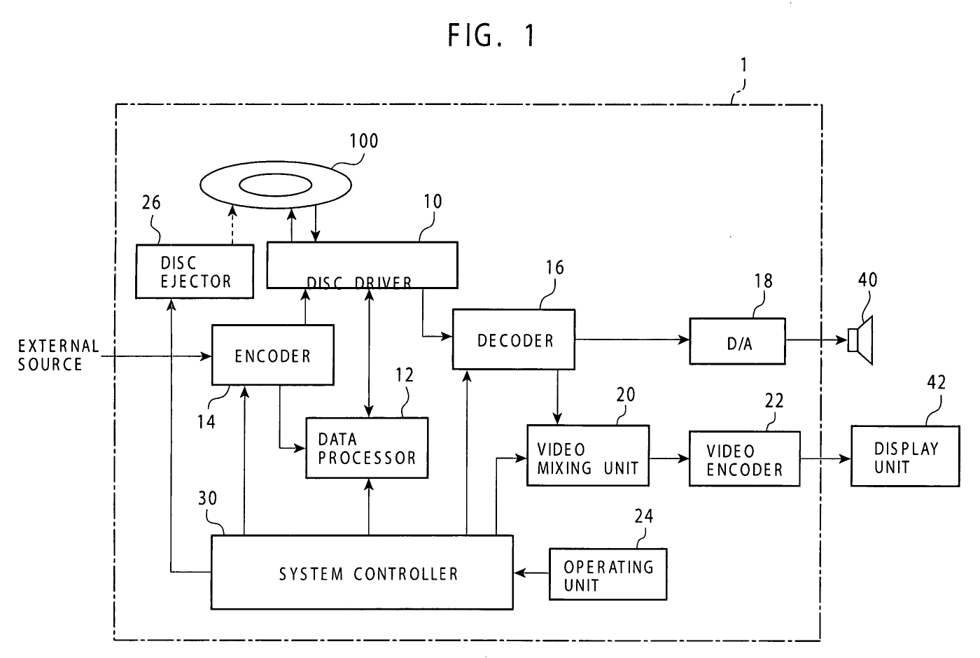

FIG. 1 is a schematic diagram of the disc recording/playback device 1 according to an embodiment of the present invention. The disc recording/playback device 1 is capable of reading data from and writing data on a data-writable optical disc 100, and is provided with a disc driver 10, a data processor 12, an encoder 14, a decoder 16, a digital/analog converter 18, a video mixing unit 20, a video encoder 22, an operating unit 24, a disc ejector 26, and a system controller 30.

The disc driver 10 rotates the optical disc 100 and reads data from or writes data on the optical disc 100. The disc driver 10 includes a rotation control component such as a servomotor, a laser driving component that emits laser beams toward a read/write position, and an optical component that detects laser beams reflected from a read/write position. The data processor 12 is for processing data in recording units or playback units, and includes a buffer circuit, a modulation/demodulation circuit, and an error corrector.

The encoder 14 is for recording video data and audio data onto the optical disc 100. The encoder 14 includes a video analog/digital converter for converting an input analog video signal to a digital video signal, an audio analog/digital converter for converting an input analog audio signal to a digital audio signal, a video encoding component for converting a digital video signal to specific modulation data for recording, and an audio encoding component for converting a digital audio signal to specific modulation data for recording.

When an analog video signal and an analog audio signal are inputted to the encoder 14 from an external source, the encoder 14 performs an encoding operation for the signals. In detail, the encoder 14 converts the analog video signal to a digital video signal and then compresses the digital video signal at a variable bit rate based on MPEG2 or MPEG1 standard. At the same time, the encoder 14 converts the analog audio signal to a digital audio signal and then compresses the digital audio signal at a constant bit rate based on MPEG or AC-3 standard. The encoded digital video signal and the encoded digital audio signal are then packed into a video pack and an audio pack, respectively. Subsequently, the video pack and the audio pack are combined and are converted to a format that complies with the DVD-VR (video recording) standard. The formatted data is then sent to the disc driver 10 via the data processor 12, and is recorded onto the optical disc 100.

The decoder 16 is for playing back video data and audio data recorded on the optical disc 100. The decoder 16 includes a data separator for separating a DVD-formatted signal, having an integrated-pack structure, into individual packs; a memory component used for the pack separation and other signal processing operations; a video decoding component for decoding main video data contained in a video pack obtained from the pack separation by the data separator; and an audio decoding component for decoding audio data contained in an audio pack obtained from the pack separation by the data separator. The decoded video data is inputted to the video mixing unit 20, and the decoded audio data is inputted to the digital/analog converter 18.

The digital/analog converter 18 converts the input decoded audio data to an analog audio signal and outputs the signal from a speaker 40.

The video mixing unit 20 combines the input decoded video data with text data that includes, for example, subtitles. The video encoder 22 converts the video data output from the video mixing unit 20 to a video signal of a specific format, such as an NTSC format. The video signal is output to a display unit 42 where a video image is displayed on a screen.

The operating unit 24 is controlled by a user to operate the disc recording/playback device 1. The operating unit 24 includes operating keys for playing back or recording video or music with respect to the optical disc 100, such as a playback command key, a record command key, and a stop command key; an eject command key for ejecting the optical disc 100; and a cursor key and an enter key for making adjustments via an operating screen.

The disc ejector 26 ejects the optical disc 100 from a predetermined load position when a user presses the eject command key in the operating unit 24.

The system controller 30 controls the playback operation and the recording operation of the disc recording/playback device 1. Furthermore, the system controller 30 provides different types of operating screens such that when a user looks at one of the screens and operates the operating unit 24, the system controller 30 performs a control operation corresponding to that selected by the user. For example, in this embodiment, the on/off state of a resume function can be set preliminarily or prior to each disc ejection, and this set-up process is controlled by the system controller 30.

Accordingly, the system controller 30 corresponds to a resume-data reading element, a confirmation element, a resume-data updating element, and a set-up element of the disc recording/playback device 1. The disc driver 10, the decoder 16, the digital/analog converter 18, the video mixing unit 20, and the video encoder 22 correspond to a playback element of the disc recording/playback device 1. The system controller 30 and the disc ejector 26 correspond to a disc-ejecting element of the disc recording/playback device 1.

An operation of the resume function provided in the disc recording/playback device 1 of this embodiment will now be described.

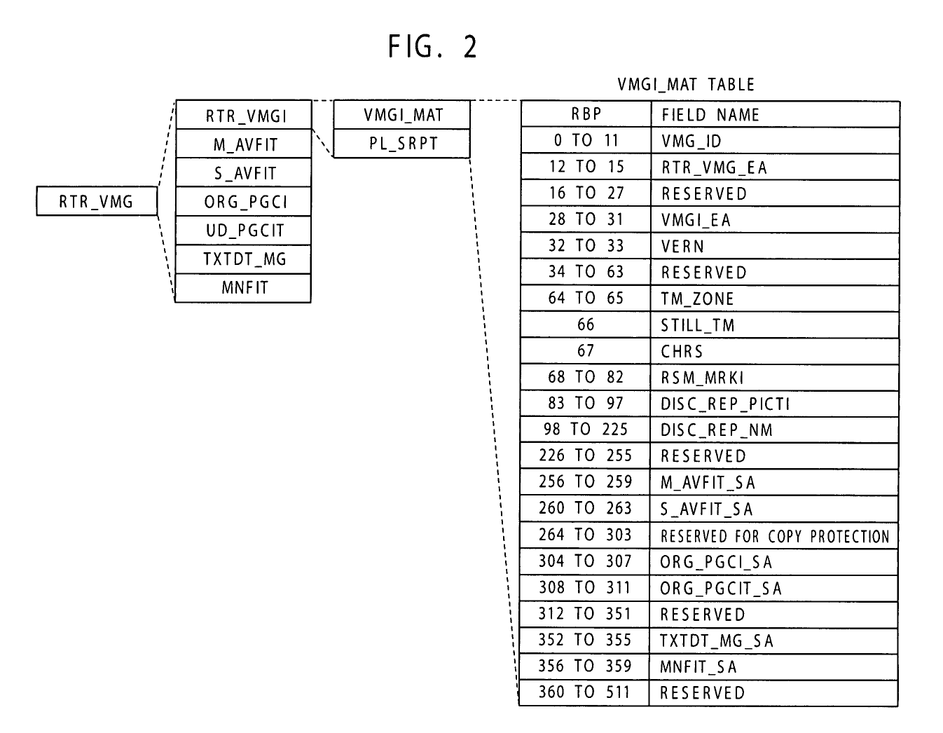

FIG. 2 illustrates the format of data written on the optical disc 100, and shows the hierarchical structure related to resume data. The optical disc 100 includes RTR_VMG, i.e. a real time recording video manager, which acts as a management area for video data to be written. The RTR_VMG includes RTR_VMGI, i.e. real time recording video manager information; M_AVFIT, i.e. a movie AV file information table; S_AVFIT, i.e. a still picture AV file information table; ORG_PGCI, i.e. original PGC information; UP_GCIT, i.e. a user defined PGC information table; TXTDT_MG, i.e. a text data manager; and MNFIT, i.e. a manufacturer's information table.

The RTR_VMGI includes VMGI_MAT, i.e. a video manager information management table; and PL_SRPT, i.e. a play list search pointer table. The VMGI_MAT includes RSM_MRKI, i.e. resume marker information, for pointing to a playback starting point on the optical disc 100 for the subsequent playback operation of the optical disc 100.

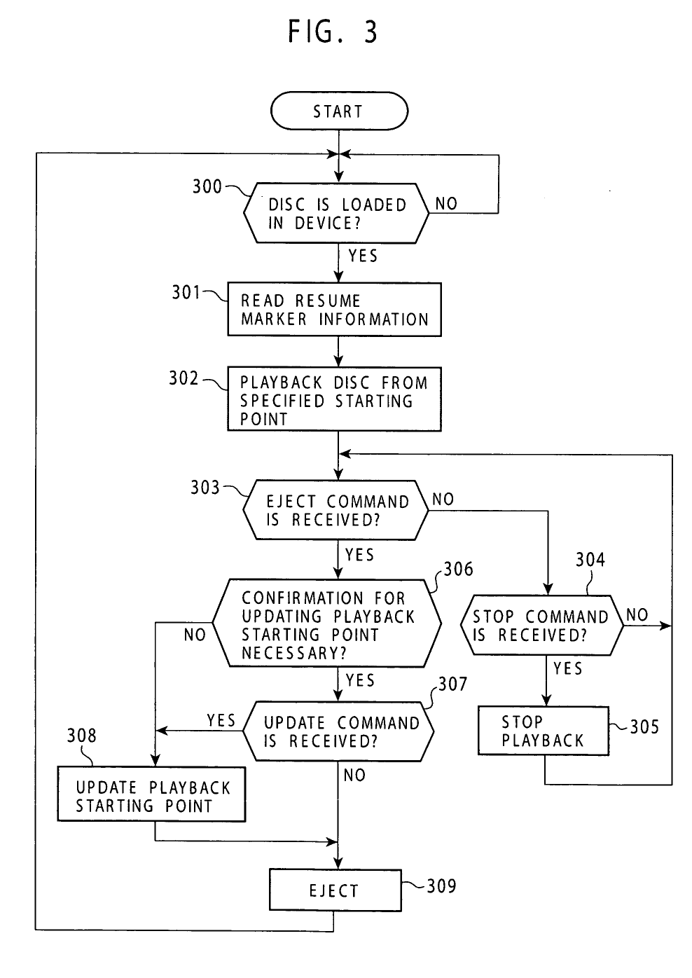

FIG. 3 is a flow chart illustrating the operational procedure of the disc recording/playback device 1 according to this embodiment. Specifically, this procedure is for updating the resume marker information (RSM_MRKI) when the optical disc 100 is to be ejected.

In act 300, the system controller 30 determines whether or not an optical disc 100 is loaded in the disc recording/playback device 1 when the power of the device 1 is turned on. If it is determined that an optical disc 100 is not loaded in the device 1, the system controller 30 repeats this determination process. If an optical disc 100 is inserted into the device 1, or if an optical disc 100 is already loaded in the device 1 when the power is turned on, the system controller 30 determines that the optical disc 100 is loaded in the device 1. Subsequently, in act 301, the system controller 30 reads the resume marker information (RSM_MRKI) in the video manager information management table (VMGI_MAT) included in the optical disc 100. In act 302, the system controller 30 controls the playback operation for the optical disc 100 from the playback starting point based on the resume marker information (RSM_MRKI).

In act 303, the system controller 30 determines whether the eject command key of the operating unit 24 is pressed by the user to eject the optical disc 100. If it is determined that the eject command key is not pressed to eject the optical disc 100 in act 303, the operation proceeds to act 304 where the system controller 30 determines whether the stop command key of the operating unit 24 is pressed by the user to stop the playback operation. If the system controller 30 determines that the stop command key is not pressed by the user, the operation returns to act 303 to repeat the determination process for the ejection command. On the other hand, if the system controller 30 determines that the stop command key is pressed by the user in act 304, the operation proceeds to act 305 where the system controller 30 stops the ongoing playback operation.

In act 303, if the system controller 30 determines that the eject command key is pressed by the user to eject the optical disc 100, the operation proceeds to act 306 where the system controller 30 determines whether user confirmation for updating of the playback starting point is necessary.

According to the disc recording/playback device 1 of this embodiment, the user can make a selection on a set-up screen between an automatic update mode for updating the resume marker information (RSM_MRKI) before every ejecting operation of the optical disc 100 as in the conventional method and an update confirmation mode in which the user is asked before each ejection of the optical disc 100 whether he/she desires updating of the resume marker information (RSM_MRKI). In a case where the update confirmation mode is selected via the set-up screen, the system controller 30 determines “YES” in act 306. The operation then proceeds to act 307 where the system controller 30 determines whether the user has commanded an update of the resume marker information (RSM_MRKI). For example, the system controller 30 displays a predetermined update confirmation screen on the display unit 42 through which the user can select whether or not to update the resume marker information (RSM_MRKI), and based on the selection by the user, the system controller 30 performs the determination process of act 307.

If it is determined in act 307 that the user has commanded an update of the resume marker information (RSM_MRKI), or in a case where the conventional method for the automatic update of the resume marker information (RSM_MRKI) is selected via the set-up screen and thus the system controller 30 determines “NO” in act 306, the operation proceeds to act 308 where the system controller 30 writes the current playback point data onto the resume marker information (RSM_MRKI) in the video manager information management table (VMGI_MAT) of the optical disc 100 to be ejected, and updates the playback starting point for the subsequent playback operation of the optical disc 100. After act 308, or if it is determined in act 307 that the user has not commanded an update of the resume marker information (RSM_MRKI), the operation proceeds to act 309 where the system controller 30 sends an ejection command to the disc ejector 26 to eject the optical disc 100.

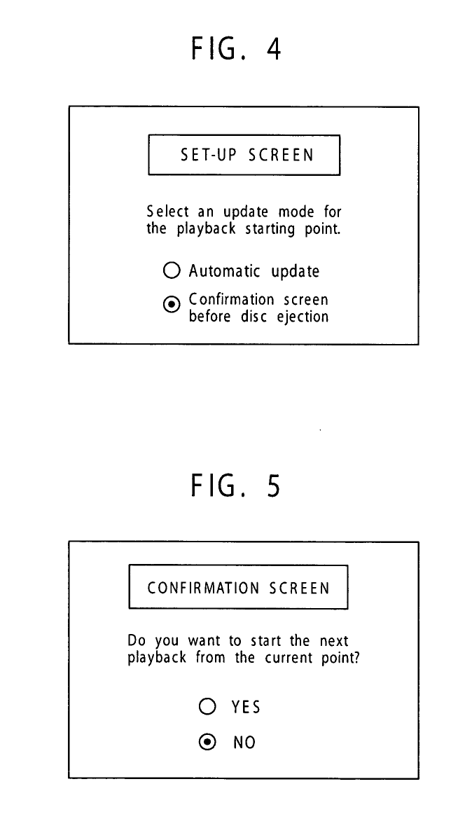

FIG. 4 illustrates an example of the set-up screen. The set-up screen in FIG. 4 includes character strings which represent “Select an update mode for the playback starting point”; and two options; i.e. “Automatic update” and “Confirmation screen before disc ejection”, between which a user can select. If a user desires to select the conventional method for updating the resume marker information (RSM_MRKI), that is, the automatic update of the resume marker information (RSM_MRKI) for every ejection of the optical disc 100, the user may use the cursor key in the operating unit 24 and select “Automatic update”, and then press the enter key. On the other hand, if the user desires to select the update confirmation mode in which the user can choose whether or not to update the resume marker information (RSM_MRKI) before each ejection of the optical disc 100, the user may select “Ask for confirmation before each ejection” with the cursor key, and then press the enter key.

FIG. 5 illustrates an example of the update confirmation screen on which the user is asked whether he/she desires updating of the resume marker information (RSM_MRKI). The update confirmation screen includes character strings which represent “Do you want to start the next playback from the current point?”; and two options, i.e. “YES” and “NO”. Similar to the conventional method, if the user desires to set the current point as the new playback starting point for the subsequent playback operation prior to the disc ejection, the user may use the cursor key in the operating unit 24 and select “YES”, and then press the enter key. On the other hand, if the user does not desire to update the resume marker information (RSM_MRKI) before the disc ejection, the user may select “NO” and then press the enter key.

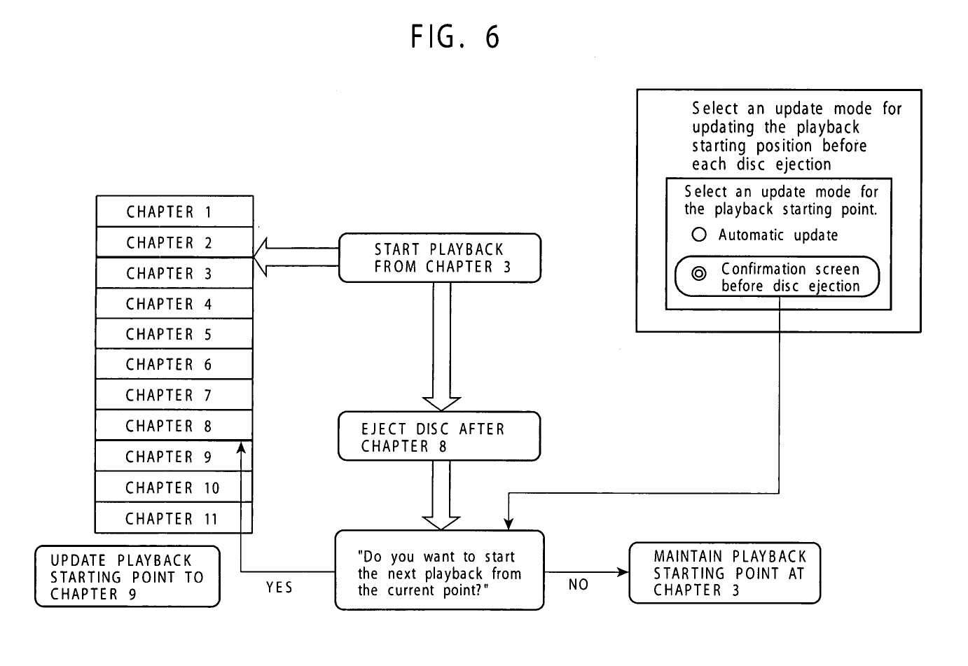

FIG. 6 illustrates an operative example of the disc recording/playback device 1 according to this embodiment. For example, the title recorded on the optical disc 100 is divided into chapters 1 to 11, and the beginning of chapter 3 is set as the playback starting point written in the resume marker information (RSM_MRKI) in the video manager information management table (VMGI_MAT) of the optical disc 100. Furthermore, the update confirmation mode, i.e. the mode that allows the user to choose whether or not to update the resume marker information (RSM_MRKI) before each ejection of the optical disc 100, is set beforehand via the set-up screen.

When the power is turned on and the optical disc 100 is inserted into the disc recording/playback device 1, the system controller 30 reads the resume marker information (RSM_MRKI) in the optical disc 100 and plays back the optical disc 100 from the playback starting point based on the resume marker information (RSM_MRKI). In this example, the playback starting point is at the beginning of chapter 3.

When the title is played back to a point just before the beginning of chapter 9 and an ejection command is received from the user, the system controller 30 displays the update confirmation screen. If the user desires updating of the resume marker information (RSM_MRKI) and selects “YES” on the update confirmation screen, the system controller 30 updates the resume marker information (RSM_MRKI) and sets the current playback point, i.e. the beginning of chapter 9, as the new playback starting point. Accordingly, when this optical disc 100 is loaded into the disc recording/playback device 1 in the future, the device 1 plays back the title on the disc 100 from the beginning of chapter 9.

On the other hand, if the user enters an ejection command for the optical disc 100 but does not desire updating of the resume marker information (RSM_MRKI) by selecting “NO” on the update confirmation screen, the system controller 30 does not update the resume marker information (RSM_MRKI), meaning that the current playback point, i.e. the beginning of chapter 9, is not set as the playback starting point. Accordingly, when the optical disc 100 is loaded into the disc recording/playback device 1 in the future, the device 1 plays back the title from the previous playback starting point, that is, the beginning of chapter 3.

Consequently, when an ejection command for the optical disc 100 is received from the user, the disc recording/playback device 1 asks the user whether he/she desires updating of the resume marker information (RSM_MRKI) and offers options for the user with regard to the updating of the resume marker information (RSM_MRKI). This means that if the resume marker information (RSM_MRKI) is not updated, the previous starting point data can be maintained. This allows the playback operation to begin from the user's desired playback starting point.

Furthermore, the operationability of the disc recording/playback device 1 is improved due to the fact that the disc recording/playback device 1 allows the user to select whether or not to update the resume marker information (RSM_MRKI) just as he/she enters an ejection command for the optical disc 100 via the operating unit 24.

Although DVD-VR standard is provided with only one area in which subsequent playback starting point data can be written, i.e. the resume marker information (RSM_MRKI), since the method of this embodiment allows the user to choose whether or not to update the content included in this area, the optical disc 100 can be played back from the user's desired playback starting point.

Furthermore, as described previously, the disc recording/playback device 1 of this embodiment includes the set-up element, i.e. the system controller 30, which is provided with the set-up screen. On this set-up screen, the user can select between the update confirmation mode for the update confirmation of the resume marker information (RSM_MRKI) via the update confirmation screen and the automatic update mode for automatically updating the resume marker information (RSM_MRKI) without the update confirmation. Accordingly, if the user selects the automatic update mode, the resume marker information (RSM_MRKI) will be automatically updated in the process of each ejecting operation for the optical disc 100, as in the conventional method. This reduces the operational steps in a case where the method of this embodiment is not applied.

Furthermore, the set-up element provided with the set-up screen operates independently of the playback operation for the data recorded on the optical disc 100. Thus, the set-up process on the set-up screen can be performed without having to stop the playback operation. Consequently, this maintains the interchangeability between the method of this embodiment and the conventional method for automatically updating the resume marker information (RSM_MRKI).

The technical scope of the present invention is not limited to the above embodiment, and modifications are permissible within the scope and spirit of the present invention. Although in one embodiment a disc recording/playback device 1 used for a DVD-VR-standard-compliant optical disc 100, the present invention can also be applied to a disc recording/playback device used for a disc-type recording medium that complies with other standards. For example, in another embodiment, an MD (mini-disc) playback device that plays back music data recorded on an MD may be used.

Furthermore, although the update confirmation mode and the automatic update mode can be selected via the set-up screen in the above embodiment, if the update confirmation were to be performed consistently before every ejecting operation, the set-up process via the set-up screen may be omitted.

What is claimed is:

1. A disc recording/playback device comprising:
a resume-data reading device operable to read resume information written in a recording area of a disc recording medium, the resume information including playback starting point data;
a playback device operable to read recorded data on the disc recording medium from a playback starting point by utilizing playback starting point data;
a confirmation device operable to determine if a user desires updating of content included in the resume information when an ejection command for the disc recording medium is received from the user;
a resume-data updating device operable to store a current playback point on a disc recording medium; and
a disc-ejecting device operable to eject a disc recording medium;
wherein the resume-data updating device updates resume information of a disc medium if the confirming device determines that a user desires updating of context and the disc-ejecting device ejects a disc after the operations of the confirmation element and the resume-data updating element are completed.

2. The disc recording/playback device of claim 1, further comprising an operating unit operable to receive an ejection command from a user.

3. The disc recording/playback device of claim 1, wherein the disc recording medium is an optical disc that complies with a DVD-VR standard.

4. The disc recording/playback device of claim 3, wherein resume information is written in the optical disc as resume marker information provided in a video manager information management table in the optical disc.

5. The disc recording/playback device of claim 3, further comprising a set-up device operable to allow a user to select between a confirmation mode for confirming an update of the resume information and an automatic update mode for automatically updating the resume information.

6. The disc recording/playback device of claim 3, further comprising a set-up element device operable to allow a user to select between a confirmation mode for confirming an update of the resume information and an automatic update mode for automatically updating the resume information,
wherein the set-up device provides a predetermined set-up screen and operates independently of playback operation for the data recorded on the disc recording medium via the set-up screen.

7. The disc recording/playback device of claim 1, further comprising a set-up device operable to allow a user to select between a confirmation mode for confirming an update of the resume information and an automatic update mode for automatically updating the resume information.

8. The disc recording/playback device of claim 7, wherein the set-up device provides a predetermined set-up screen and operates independently of playback operation for the data recorded on the disc recording medium via the set-up screen.

9. A method for reading data from and writing data on a disc recording medium in a disc recording/playback device, comprising:
providing a disc recording medium, the disc recording medium including resume information written in a recording area of the disc recording medium, the resume information including playback starting point data;
reading the resume information;
reading recorded data on the disc recording medium from a playback starting point;
receiving an ejection command;
determining that a user desires updating of content included in the resume information;
updating the content of the resume information by setting a current playback point on the disc recording medium as a new playback starting point; and
ejecting the disc recording medium in response to the ejection command after the resume information is updated.

10. The method of claim 9, wherein the disc recording medium is an optical disc that complies with a DVD-VR standard.

11. The method of claim 10, wherein the resume information is written in the optical disc as resume marker information provided in a video manager information management table in the optical disc.

12. The method of claim 9 further comprising the act of receiving a request to automatically update resume information without confirmation.

13. The method of claim 9 further comprising the act of providing a set-up screen.

14. The method of claim 13 wherein the set-up screen operates independently of playback operation.

15. A method for reading data from and writing data on a disc recording medium in a disc recording/playback device, comprising:
providing a disc recording medium, the disc recording medium including resume information written in a recording area of the disc recording medium, the resume information including playback starting point data;
reading the resume information;
reading recorded data on the disc recording medium from a playback starting point;
receiving an ejection command;
determining that a user desires updating of content included in the resume information to be automatically updated placing the disc recording playback device in automatic update mode;
updating the content of the resume information by setting a current playback point on the disc recording medium as a new playback starting point; and
ejecting the disc recording medium in response to the ejection command after the resume information is updated.

16. The method of claim 15 further comprising the act of providing a set-up screen.

17. The method of claim 16 wherein the set-up screen operates independently of playback operation.
